(19) United States
(12) Patent Application Publication
(10) Pub. No.: US 2019/0348009 A1
(43) Pub. Date: Nov. 14, 2019

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/400,139

(22) Filed: May 1, 2019

(30) Foreign Application Priority Data
May 11, 2018 (JP) 2018-092519

(51) Int. Cl. G09G 5/00; G09G 5/14

(52) U.S. Cl. CPC G09G 5/003; G09G 2380/02; G09G 2354/00; G09G 5/14

(57) ABSTRACT

An information processing apparatus includes an acceptance unit that accepts designation of a region to be used to display information on a display unit having a curved display surface.

### CROSS-REFERENCE TO RELATED APPLICATIONS

This application is based on and claims priority under 35 USC 119 from Japanese Patent Application No. 2018-092519 filed May 11, 2018.

### BACKGROUND

### (i) Technical Field

The present disclosure relates to an information processing apparatus, an information processing system, and a non-transitory computer readable medium.

### (ii) Related Art

Nowadays, display devices having a bendable display surface are available. A display device of this type is called a flexible display and realized by using a sheet of so-called electronic paper, a liquid crystal panel, an organic electroluminescence panel, or the like (for example, refer to Japanese Unexamined Patent Application Publication No. 2008-283350). A technique to display a spherical image as if the image were floating in the air is also available.

### SUMMARY

Aspects of non-limiting embodiments of the present disclosure relate to improving user visibility of a display unit having a curved display surface.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an acceptance unit that accepts designation of a region to be used to display information on a display unit having a curved display surface.

### BRIEF DESCRIPTION OF THE DRAWINGS

Exemplary embodiments of the present disclosure will be described in detail based on the following figures, wherein:

FIGS. 1A and 1B illustrate an example of an information processing apparatus according to the first exemplary embodiment, FIG. 1A illustrates an example of the information processing apparatus in use, and FIG. 1B is a side view of the information processing apparatus;

FIG. 2 illustrates an example hardware configuration of the information processing apparatus according to the first exemplary embodiment;

FIG. 3 illustrates an example functional configuration realized by a central processing unit (CPU) through program execution;

FIGS. 4A and 4B illustrate an example in which a user points with a finger at a position specifying the upper edge and a position specifying the lower edge of a display region, FIG. 4A illustrates an operation by the user, and FIG. 4B illustrates the display region being specified;

FIGS. 5A and 5B illustrate an example in which a user points with a finger at a corner on the upper edge of a display region and at a corner on the lower edge of the display region, the corner being at the opposite end of a diagonal of the display region, FIG. 5A illustrates an operation by the user, and FIG. 5B illustrates the display region being specified;

FIGS. 6A and 6B illustrate an example in which a user points with a finger at a portion of the upper edge and a portion of the lower edge of a display region, FIG. 6A illustrates an operation by the user, and FIG. 6B illustrates the display region being specified;

FIGS. 7A and 7B illustrate an example in which a user specifies a frame that provides the boundary of a display region by drawing a line with a finger, FIG. 7A illustrates an operation by the user, and FIG. 7B illustrates the display region being specified;

FIGS. 8A and 8B illustrate a case where the aspect ratio of a display region is given in advance and it is predetermined that a portion specified by a user is recognized as a certain portion of the boundary of the display region, FIG. 8A illustrates an operation by the user, and FIG. 8B illustrates the display region being specified;

FIGS. 9A and 9B illustrate an example in which the aspect ratio of a display region is given in advance but it is not predetermined that a portion specified by a user is recognized as a certain portion of the boundary of the display region, FIG. 9A illustrates an operation by the user, and FIG. 9B illustrates the display region being specified;

FIGS. 10A and 10B illustrate another example in which the aspect ratio of a display region is given in advance but it is not predetermined that a portion specified by a user is recognized as a certain portion of the boundary of the display region, FIG. 10A illustrates an operation by the user, and FIG. 10B illustrates the display region being specified;

FIGS. 11A, 11B, and 11C illustrate an example in the case where the form of an information processing apparatus is freely deformable, FIG. 11A illustrates a basic form with no bend, FIG. 11B illustrates a case of a small bend, and FIG. 11C illustrates a case of a large bend;

FIGS. 12A and 12B illustrate another example of an information processing apparatus having a display surface formed so as to surround the main body, FIG. 12A illustrates an operation by a user, and FIG. 12B illustrates the display region being specified;

FIGS. 13A and 13B illustrate an example of setting a display region of an information processing apparatus having a display surface of a spherical shape, FIG. 13A illustrates an operation by a user, and FIG. 13B illustrates the display region being specified;

FIGS. 14A and 14B illustrate an example of setting a display region of an information processing apparatus having a concave display surface, FIG. 14A is a perspective view of a relative position of the display surface with respect to a user, and FIG. 14B is a top view of the relative position of the display surface with respect to the user;

FIGS. 15A, 15B, and 15C illustrate an example of an information processing apparatus according to the second exemplary embodiment, FIG. 15A illustrates a case where an image is output only to a display device having a display surface of a spherical shape, FIG. 15B illustrates a case where an image is output to a display device of a planar shape and a display device having a display surface of a spherical shape, and FIG. 15C illustrates a change in the setting of a display region in a case where the display device of a planar shape is placed facing a different direction;

FIG. 16 illustrates an example functional configuration realized by the CPU of an image processing apparatus through program execution;

FIGS. 17A and 17B illustrate a method of setting a print region in the third exemplary embodiment, FIG. 17A illustrates an example of setting a print region on a display surface of a cylindrical shape, and FIG. 17B illustrates a print result;

FIG. 18 illustrates an example of a function realized by the CPU through program execution;

FIGS. 19A and 19B illustrate a case where one edge is specified and printing is performed in the clockwise direction, FIG. 19A illustrates an operation by a user, and FIG. 19B illustrates a print result;

FIGS. 20A and 20B illustrate a case where two edges are specified and printing is performed in the counterclockwise direction, FIG. 20A illustrates an operation by a user, and FIG. 20B illustrates a print result;

FIGS. 21A and 21B illustrate examples in a case where a print direction is determined in accordance with the content of a displayed image, FIG. 21A illustrates a print direction in a case where text characters are arranged from top to bottom, and FIG. 21B illustrates a print direction in a case where text characters are arranged from left to right;

FIGS. 22A and 22B illustrate an example of printing in a case where display regions are distinguishable in accordance with the physical form of a display surface, FIG. 22A illustrates an example of regions, each of which is managed as a print unit, and FIG. 22B illustrates a print result in a case where all the regions are selected as an object to print;

FIGS. 23A and 23B illustrate another example of printing in a case where display regions are distinguishable in accordance with the physical form of a display surface, FIG. 23A illustrates an example of regions, each of which is managed as a print unit, and FIG. 23B illustrates a print result in a case where a single region is selected as an object to print;

FIGS. 24A and 24B illustrate a principle of an aerial image forming apparatus, which forms an aerial image by using light that is output from a display device and that thereafter passes through a dedicated optical plate, FIG. 24A illustrates a relative position of the aerial image with respect to each component, and FIG. 24B illustrates a portion of a sectional view of the structure of the optical plate;

FIG. 25 illustrates a principle of an aerial image forming apparatus, which forms a three-dimensional image as an aerial image;

FIGS. 26A and 26B illustrate a principle of an aerial image forming apparatus to form an aerial image by using a micromirror array, which has a structure having tiny rectangular holes each of which constitutes a dihedral corner reflector and that are arranged in a plane at a constant pitch, FIG. 26A illustrates a relative position of the aerial image with respect to each component, and FIG. 26B is an enlarged view of a portion of the micromirror array; and

FIG. 27 illustrates a principle of an aerial image forming apparatus, which forms an aerial image as a collection of plasma light emitters.

### DETAILED DESCRIPTION

Hereinafter, exemplary embodiments of the present disclosure will be described with reference to the drawings.

### First Embodiment

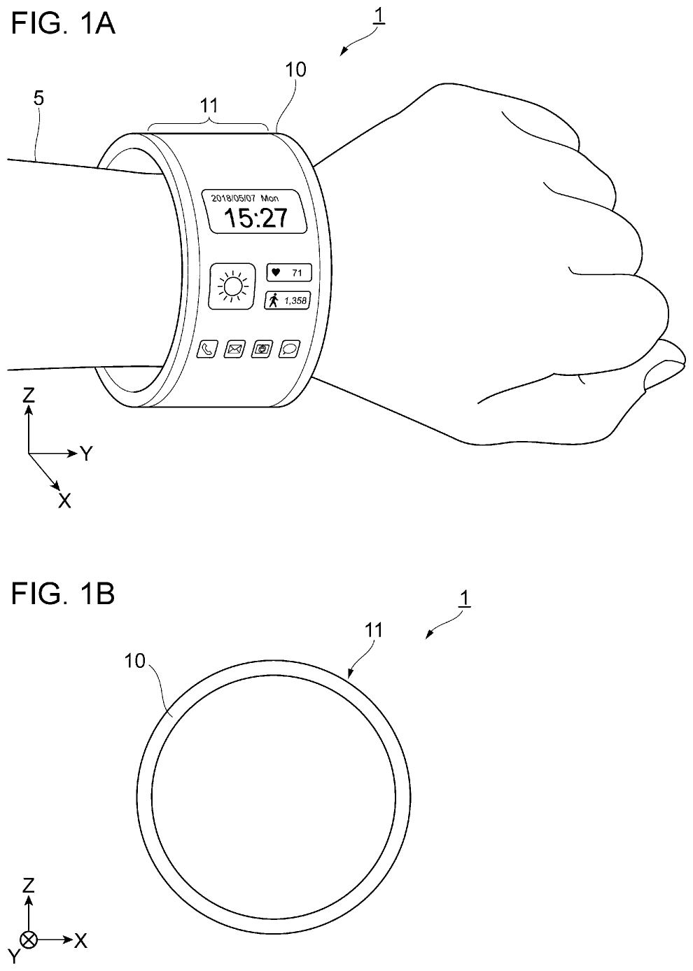

FIGS. 1A and 1B illustrate an example of an information processing apparatus 1 according to the first exemplary embodiment. FIG. 1A illustrates an example of the information processing apparatus 1 in use, and FIG. 1B is a side view of the information processing apparatus 1. The information processing apparatus 1 illustrated in FIG. 1A is mounted on an arm 5 of a user. In the present exemplary embodiment, the information processing apparatus 1 has a configuration in which a display surface 11 is disposed along the outer perimeter of a main body 10 of a cylindrical shape. The display surface 11 in FIG. 1A is disposed along the entire perimeter of the main body 10. In other words, the display surface 11 is an example of a 360° display unit.

The display surface 11 in the present exemplary embodiment is physically continuous over the entire perimeter. However, the display surface 11 may be constituted by an assembly made of a plurality of display devices provided that the assembly may be used in a manner similar to the display surface 11 covering continuously the entire perimeter. The largest display region of the display surface 11 in the present exemplary embodiment is the entire perimeter in the circumferential direction and the entire width in the width direction. In other words, the entire area of the display surface 11, which may be viewed by a user, is the largest region used to display information.

In the present exemplary embodiment, the display surface 11 is constituted by an organic electroluminescence (EL) panel, a liquid crystal panel, or the like. As depicted in FIG. 1A, information such as the weather, time, pulse rate, and pedometer count and functional buttons such as for email and telephone are presented on the display surface 11. The display surface 11 displays not only a static image but also a moving image. The display surface 11 may display output values of various sensors built into the main body 10, information received from outside via a communication function, and information read from a storage device (not depicted).

In the present exemplary embodiment, the main body 10 is formed into a cylindrical shape. The main body 10 may be formed so as to open at a position on the perimeter and may be attachable to and detachable from the arm 5. A connecting member such as a clasp (not depicted) may be attached to the ends at the position where the main body 10 opens. The main body 10 may be a component that has a band-like form and that is formed of a flexible material. In the present exemplary embodiment, the display surface 11 is attached to the main body 10 so as to extend continuously over the entire perimeter of the main body 10 when the main body 10 is mounted on the arm 5. However, a gap where the display surface 11 is not present may be formed in the circumferential direction when the main body 10 is mounted on the arm 5. For example, the display surface 11 may extend over an arc of 350, 300, 180, or 120 degrees in the circumferential direction.

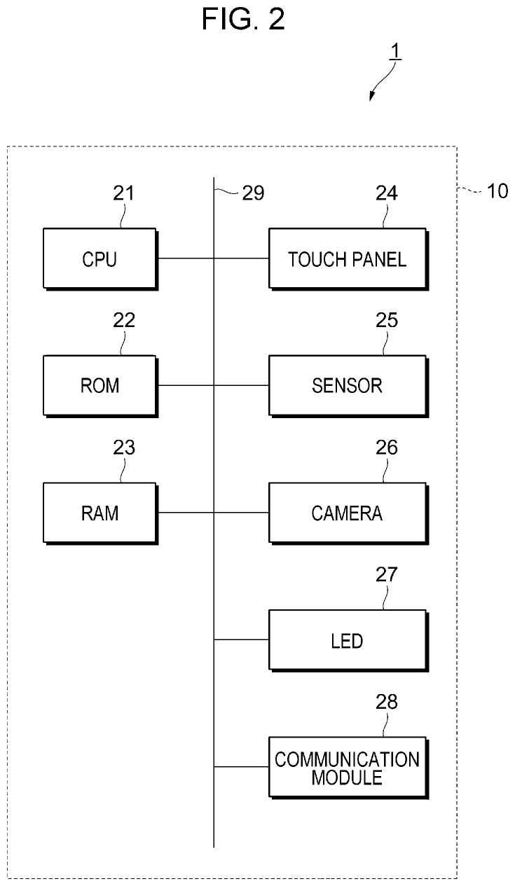

FIG. 2 illustrates an example hardware configuration of the information processing apparatus 1 according to the first exemplary embodiment. The main body 10 of a cylindrical shape includes a central processing unit (CPU) 21, which controls the entire apparatus through program (including firmware) execution, a read-only memory (ROM) 22, which stores programs such as a basic input output system (BIOS) and firmware, and a random access memory (RAM) 23, which is used as an execution area for programs. The CPU 21, the ROM 22, and the RAM 23 function as a computer and execute various information processes. The ROM 22 is constituted by a nonvolatile semiconductor memory.

In addition, the main body 10 includes a touch panel 24, which constitutes the display surface 11 (refer to FIG. 1A), a sensor 25, which outputs an electric signal representing a physical quantity to be observed, a camera 26, which captures an image, a light emitting diode (LED) 27, which is disposed as a light source, a communication module 28, which is used to communicate with external apparatuses, and the like. These units are connected to each other via a bus 29. The touch panel 24 includes an operation detection device to detect a position on the display surface 11, which is operated by a user, and a display device to display information. For example, an organic EL panel or a liquid crystal panel is used as a display device.

Examples of the sensor 25 include a temperature sensor, an atmospheric temperature sensor, a body temperature sensor, a pulse rate sensor, an acceleration sensor, a gyro sensor, a magnetic field sensor, a global positioning system (GPS) sensor, an ambient light sensor, a proximity sensor, and a fingerprint sensor. The output from an acceleration sensor is used, for example, to measure the number of steps of a person walking. It is not necessary to use as the sensor 25 all of the sensors mentioned here as examples, and only some of them may be used. The communication module 28 includes, for example, a wireless fidelity (Wi-Fi, registered trademark) module, which transmits and receives a wireless signal conforming to the Wi-Fi standard, and a Bluetooth (registered trademark) module, which transmits and receives a wireless signal conforming to the Bluetooth standard, which is one of the short-range wireless communication standards.

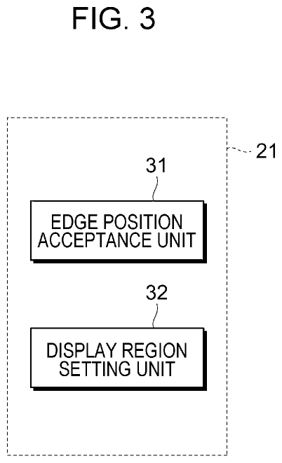

FIG. 3 illustrates an example functional configuration realized by the CPU 21 through program execution. However, the functional configuration illustrated in FIG. 3 represents only functions to set a region for display (hereinafter, referred to as a “display region”). In the present exemplary embodiment, functions to set a display region are provided because a user is not able to simultaneously view all the information displayed in the entire region of the largest display region of the display surface 11 of a cylindrical shape, which is adopted in the present exemplary embodiment (refer to FIGS. 1A and 1B).

For example, a portion of the display surface 11 on the other side of the main body 10 from the user is located in a so-called bind spot, and thus it is necessary to rotate the main body 10 (refer to FIG. 1A) so that the user is able to face the portion of the display surface 11 on the other side and view information displayed thereon. Further, for example, information displayed on a portion of the display surface 11 that is nearly parallel to the line of sight of the user may be viewed, but it is difficult for the user to grasp the content of the information. In addition, for example, when the relative position of the display surface 11 with respect to the user changes as in the case where the user moves the arm 5 (refer to FIG. 1A) or the head, the region of the display surface 11 that may be viewed by the user changes.

Thus, the CPU 21 serves as an edge position acceptance unit 31, which accepts an edge position that defines a display region, and a display region setting unit 32, which sets the display region in accordance with the accepted position. Here, the CPU 21 serves as an example of an acceptance unit, which accepts settings for a region that is a portion of the largest display region of the display surface 11 and that is used to display information.

Instructions may be input into the edge position acceptance unit 31 to specify edge positions, for example, by specifying one or more edge positions in the direction that the display surface 11 curves or by specifying the entire boundary of the display region. Information to specify an edge position includes information to specify a corner of the region. An edge position may be specified by a point or a line segment. Whether a line segment is accepted as the entire boundary of a display region or as a portion of the boundary of a display region depends on predetermined settings. Settings regarding an acceptance method may be changed by the user.

The display region setting unit 32 basically designates as a display region a region bounded by accepted edge positions. No image is displayed outside the display region after the display region is designated. However, function buttons or images selected in advance may be displayed and may remain at fixed positions in a portion outside the display region in the largest display region. For example, a home button to display a home screen in the display region or a return button to return a screen displayed in the display region to the preceding screen may be displayed. It is basically difficult for a user in a viewing posture to view a region outside the display region, but, for example, turning the main body 10 enables the user to easily view a region outside the display region. Thus, the amount of work necessary to display buttons corresponding to the above operations in the display region is reduced.

The display region setting unit 32 may provide a function of using positions physically determined on the display surface 11 to partially specify edges defining the display region. If this function is provided, a user need only specify one or two edges among the remaining two edges of the display region, and the amount of work to specify edges is reduced. One or two edges defining the boundary of the display region may also be specified in a region bounded by two edges that provide the physical boundary of the display region. The display region setting unit 32 may also provide a function of specifying a position of the edge on the other side of the display region from an accepted edge in accordance with the accepted edge and a size (or aspect ratio) of an image to be displayed.

### Examples of Setting Display Region

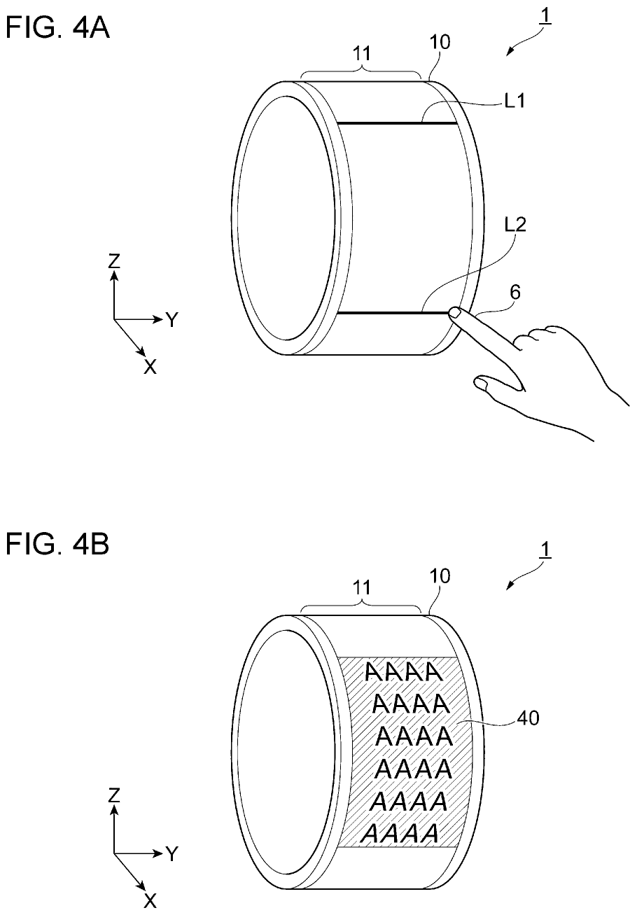

Examples of setting a display region will be described below with reference to FIGS. 4A to 10B. FIGS. 4A and 4B illustrate an example in which a user points with a finger 6 at a position specifying an upper edge L1 and a position specifying a lower edge L2 of a display region 40. FIG. 4A illustrates an operation by the user, and FIG. 4B illustrates the display region 40 being specified. In FIGS. 4A and 4B, the same numerals denote corresponding portions in FIGS. 1A and 1B. In the example in FIG. 4A, the finger 6, which is in contact with the display surface 11, is moved in the direction (Y direction in FIG. 4A) intersecting the curving direction of the display surface 11, and thereby specifies the positions of the two edges that define the display region 40.

In the example in FIG. 4A, the finger 6 starts moving at a point on the physical boundary on one side of the display surface 11 and stops moving at a point on the physical boundary on the other side of the display surface 11. Thus, the edges along the curve of the display region 40 are automatically designated as the range delimited by the upper edge L1 and the lower edge L2 on the display surface 11. When these four edges are specified, the display region 40 is set. The display region 40 illustrated in FIG. 4B displays an image presenting “AAAA/AAAA/AAAA/AAAA/AAAA/AAAA”, where a slash represents a line break. The positions of the upper edge L1 and the lower edge L2, which are specified by the user, may be presented on the display surface 11 during the operation by the user. If the upper edge L1 or the lower edge L2 is presented, it serves as guidance for the user to specify the other edge. Whether or not to display the upper edge L1 or the lower edge L2 during the operation of specifying the edges may be selectable.

In FIG. 4A, for the sake of description, no image is displayed on the display surface 11 (or a white screen is displayed) during the operation of specifying the edges, but a region to be used as the display region 40 may be designated while an image is being displayed on the display surface 11. Typically, a region to be easily viewed by a user is designated as the display region 40, and thus displaying an image enables the user to easily visualize the size of a region to secure as the display region 40. Repeating the operation, for example, in the case where an image to be displayed is not contained in the region designated as the display region 40 is avoidable. The largest area for the display region 40 is the largest display region. In this example, the largest area for the display region 40 coincides with the display surface 11.

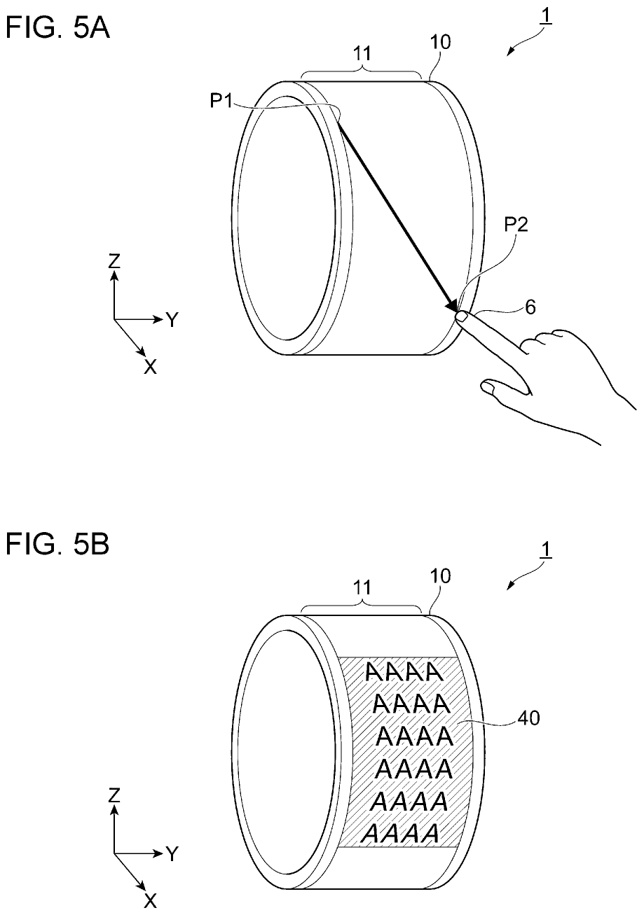

FIGS. 5A and 5B illustrate an example in which a user points with the finger 6 at a corner P1 on the upper edge of the display region 40 and at a corner P2 on the lower edge of the display region 40, the corner P2 being at the opposite end of a diagonal of the display region 40. FIG. 5A illustrates an operation by the user, and FIG. 5B illustrates the display region 40 being specified. In FIGS. 5A and 5B, the same numerals also denote corresponding portions in FIGS. 1A and 1B. In the example in FIG. 5A, the finger 6, which is in contact with the display surface 11, is moved from the upper left to the lower right. Naturally, the finger 6 may be moved from the lower right to the upper left or from the upper right to the lower left. In the example in FIG. 5A, the position where the finger 6 starts moving is also on the boundary on the left-hand side of the display surface 11, and the position where the finger 6 stops moving is also on the boundary on the right-hand side of the display surface 11. Thus, the edge on the left-hand side of the display region 40 is set so as to extend along the boundary on the left-hand side of the display surface 11, and the edge on the right-hand side of the display region 40 is set so as to extend along the boundary on the right-hand side of the display surface 11.

In the example in FIGS. 5A and 5B, when the user moves the finger 6, which is in contact with the display surface 11, in the diagonal direction, the display region 40 is set so that the start point of the movement (upper corner P1 in FIG. 5A) and the end point of the movement (lower corner P2 in FIG. 5A) provide a diagonal of the display region 40, but only the two points that provide diagonal positions may be specified. For example, two points on opposite sides of a diagonal on the display surface 11 (for example, the upper left corner P1 and the lower right corner P2) may be specified. Even in such a case, if the display region 40 has a rectangular shape, the region to be used as the display region 40 may also be designated.

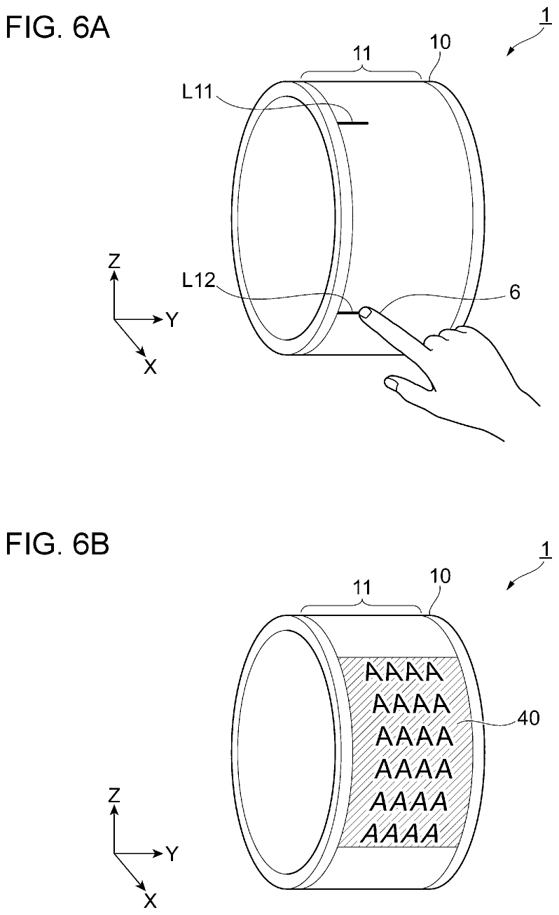

FIGS. 6A and 6B illustrate an example in which a user points with the finger 6 at a portion of the upper edge (line segment L11) and a portion of the lower edge (line segment L12) of the display region 40. FIG. 6A illustrates an operation by the user, and FIG. 6B illustrates the display region 40 being specified. In FIGS. 6A and 6B, the same numerals also denote corresponding portions in FIGS. 1A and 1B.

In the example in FIG. 6A, a line segment or a point is used for the user to specify a portion of an edge of the display region 40. Thus, in FIG. 6A, the display region 40 is set so that the line segment L11 and the line segment L12 constitute a portion of the upper edge and a portion of the lower edge, respectively. In the example in FIG. 6A, the line segment L11 on the upper edge and the line segment L12 on the lower edge are both specified on the left-hand side of the display surface 11 but may be specified on the right-hand side of the display surface 11 or at opposite ends of a diagonal. Further, in the example in FIG. 6A, the line segment L11 on the upper edge and the line segment L12 on the lower edge are provided, but a point on the upper edge and a point on the lower edge may be provided.

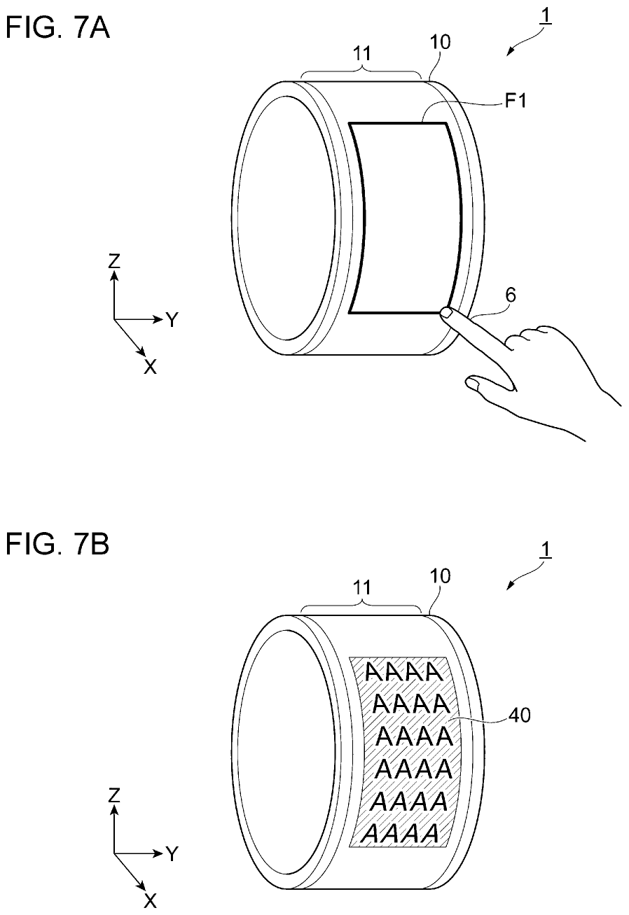

FIGS. 7A and 7B illustrate an example in which a user specifies a frame F1 that provides the boundary of the display region 40 by drawing a line with the finger 6. FIG. 7A illustrates an operation by the user, and FIG. 7B illustrates the display region 40 being specified. In FIG. 7A, the boundary of the display region 40 is drawn directly on the display surface 11, and thus any shape may be specified. Drawing with the finger 6 is likely to cause distortion, and thus a function to approximate a drawn line as a straight line or a curve may be combined.

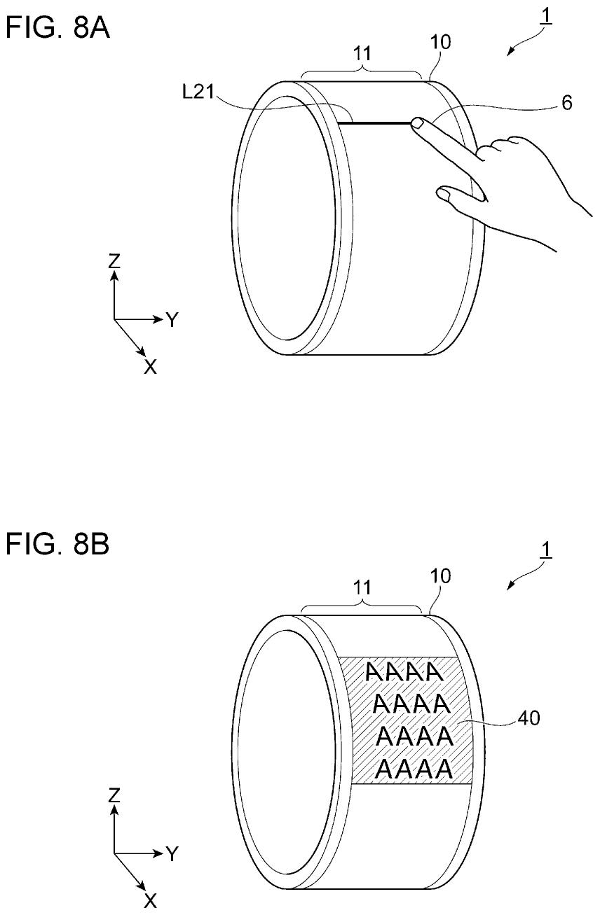

FIGS. 8A and 8B illustrate a case where the aspect ratio of the display region 40 is given in advance and it is predetermined that a portion specified by a user is recognized as a certain portion of the boundary of the display region 40. FIG. 8A illustrates an operation by the user, and FIG. 8B illustrates the display region 40 being specified. In FIG. 8A, it is predetermined that a position specified by the finger 6 provides the position of the upper edge of the display region 40. Thus, the display region 40 is set with respect to the path on which the finger 6 has moved (line segment L21).

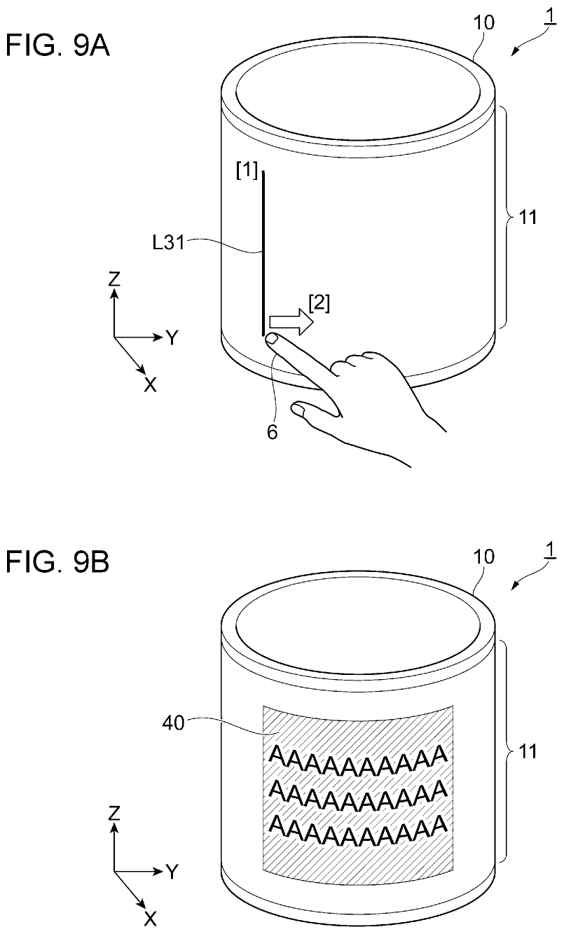

FIGS. 9A and 9B illustrate an example in which the aspect ratio of the display region 40 is given in advance but it is not predetermined that a portion specified by a user is recognized as a certain portion of the boundary of the display region 40. FIG. 9A illustrates an operation by the user, and FIG. 9B illustrates the display region 40 being specified. In FIG. 9A, the finger 6 is moved parallel to the rotation axis of the main body 10 of a cylindrical shape. The path on which the finger 6 has moved is provided by a line segment L31. In FIG. 9A, the line segment L31 provides an edge of the display region 40 in the longitudinal direction. At this time point, whether the line segment L31 provides the edge on the left-hand side or the edge on the right-hand side is unknown. Next, the user moves the finger 6 in the direction in which the display region 40 is desirably formed. In FIG. 9A, the finger 6, which is in contact with the display surface 11, is moved in the counterclockwise direction. Thus, it is determined that the line segment L31 is the left edge of the display region 40. Once the position of the left edge is determined, the display region 40 is set in accordance with the predetermined aspect ratio.

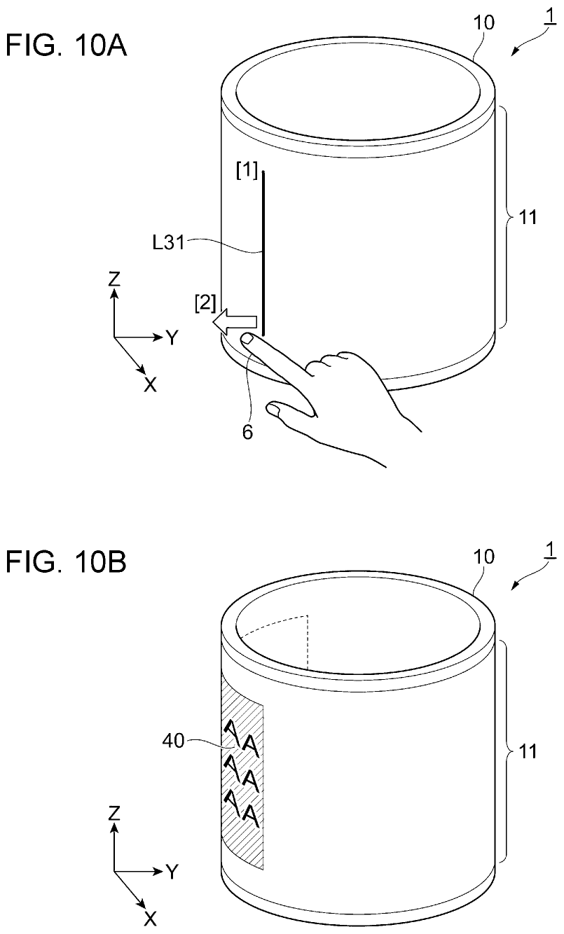

FIGS. 10A and 10B illustrate another example in which the aspect ratio of the display region 40 is given in advance but it is not predetermined that a portion specified by a user is recognized as a certain portion of the boundary of the display region 40. FIG. 10A illustrates an operation by the user, and FIG. 10B illustrates the display region 40 being specified. In FIG. 10A as in FIG. 9A, the finger 6 is also moved parallel to the rotation axis of the main body 10 of a cylindrical shape, and the line segment L31 is set. However, in FIG. 10A, the finger 6, which is in contact with the display surface 11, is moved in the clockwise direction. Thus, it is determined that the line segment L31 is the right edge of the display region 40. Once the position of the right edge is determined, the display region 40 is set in accordance with the predetermined aspect ratio.

### Modifications

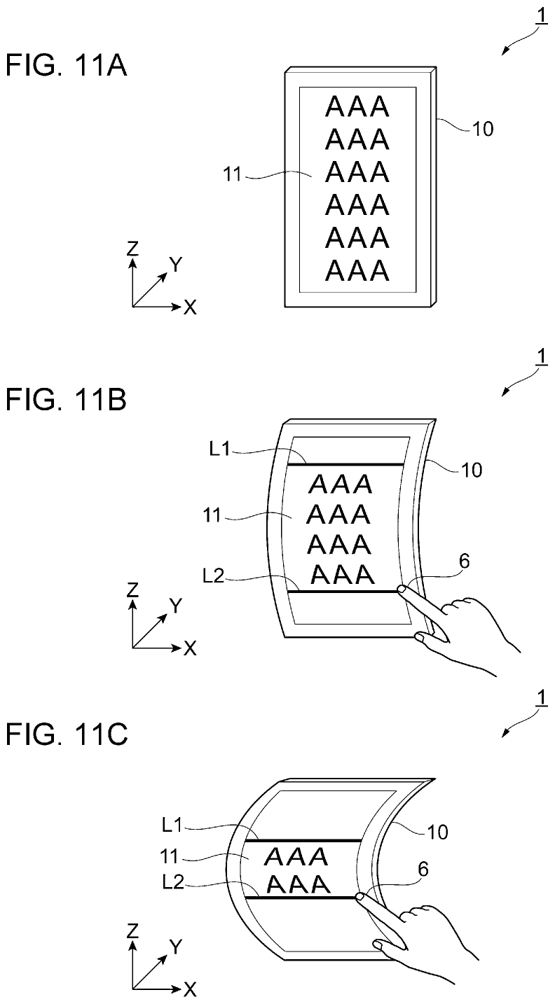

In the above description, the information processing apparatus 1 has a cylindrical appearance, but the appearance of the information processing apparatus 1 in the present exemplary embodiment may have a different form. FIGS. 11A, 11B, and 11C illustrate an example in the case where the form of the information processing apparatus 1 is freely deformable. FIG. 11A illustrates a basic form with no bend, FIG. 11B illustrates a case of a small bend, and FIG. 11C illustrates a case of a large bend. The information processing apparatus 1 illustrated in FIGS. 11A to 11C is also called a flexible display apparatus, and examples of the information processing apparatus 1 of this type include a tablet terminal, a smartphone, a sheet of electronic paper, a terminal capable of being wound into a body for storing and unwound from the body for use like a scroll, and a terminal that has a band-like form and that, when in use, is deformed so as to be wound, for example, around an arm.

The information processing apparatus 1 illustrated in FIGS. 11A to 11C has a structure including a main body 10, which is thin and easily deformable, and a display surface 11, which is also easily deformable and is disposed on the surface of the main body 10. In FIGS. 11A to 11C, the display surface 11 is disposed only on a single face among six faces. A hardware configuration inside the information processing apparatus 1 illustrated in FIGS. 11A to 11C is the same as the configuration described with reference to FIG. 2. In FIGS. 11B and 11C, a wide area is designated as a display region 40 when the longer side of the information processing apparatus 1 is bent by a small amount, and a narrow area is designated as the display region 40 when the longer side of the information processing apparatus 1 is bent by a large amount. In FIGS. 11B and 11C as in FIGS. 4A and 4B, the upper edge L1 and the lower edge L2 are specified.

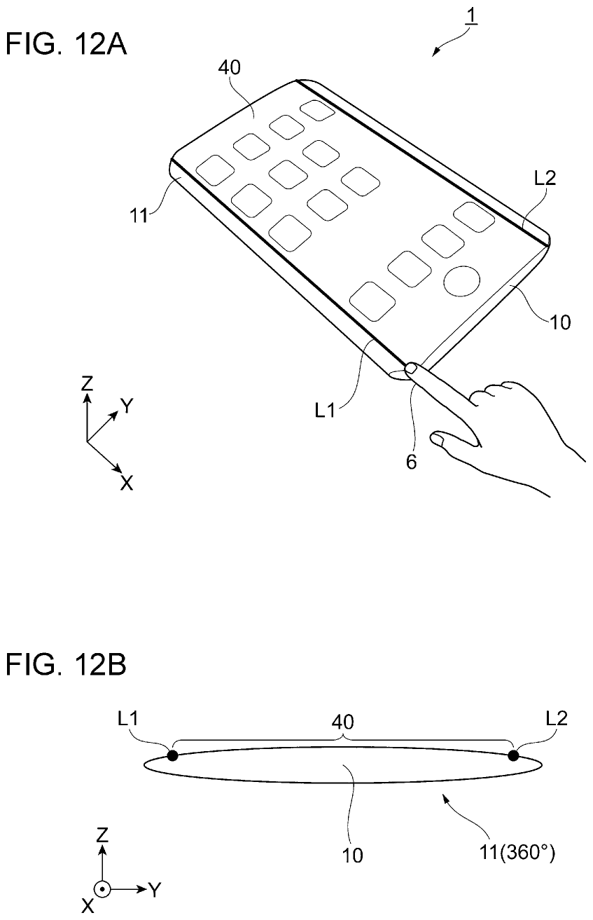

FIGS. 12A and 12B illustrate another example of the information processing apparatus 1 having a display surface 11, which is formed so as to surround a main body 10. FIG. 12A illustrates an operation by a user, and FIG. 12B illustrates a display region 40 being specified. The information processing apparatus 1 illustrated in FIGS. 1A and 1B has a cylindrical appearance, but the information processing apparatus 1 illustrated in FIGS. 12A and 12B has a planar shape similar to the shape of the information processing apparatus 1 illustrated in FIGS. 11A to 11C. However, the information processing apparatus 1 illustrated in FIGS. 12A and 12B does not deform, and instead all of the front face, the right side face, the back face (rear face), and the left side face integrally form the display surface 11. In other words, an image is displayed all around (360°) the display surface 11.

Thus, the back face (rear face) is a so-called blind spot when viewed from the position of the user. In addition, the right side face is also a blind spot in the example in FIGS. 12A and 12B. Naturally, it makes sense to display an image in a region included in a blind spot for a user who uses the information processing apparatus 1 in a manner such that an image displayed on the back face is moved to the front face by moving a finger touching any position on the surface in the right and left directions (so-called swiping). But some users also think that it is unnecessary to display an image in a region that is included in a blind spot when in use. The example in FIGS. 12A and 12B illustrates the use by such a user. In FIGS. 12A and 12B, the display region 40 is set only to the front face, and no image is displayed on the back (rear) face, the right side face, or the left side face.

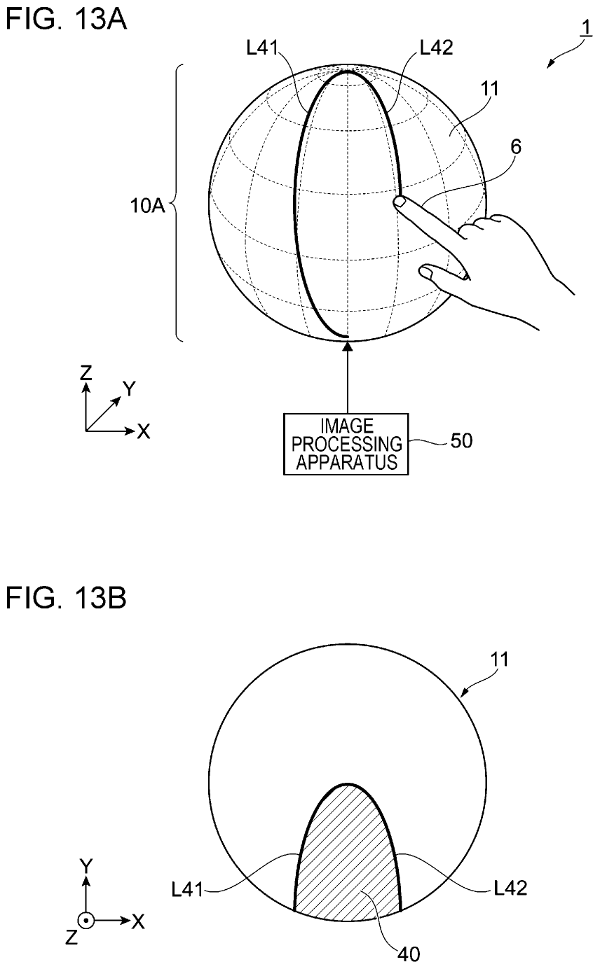

FIGS. 13A and 13B illustrate an example of setting a display region 40 of the information processing apparatus 1 having a display surface 11 of a spherical shape. FIG. 13A illustrates an operation by a user, and FIG. 13B illustrates the display region 40 being specified. The information processing apparatus 1 illustrated in FIGS. 13A and 13B includes a display device 10A having the display surface 11, which is a highly transparent sphere and is formed from glass or plastic resin, and an image processing apparatus 50. Here, the image processing apparatus 50 includes a CPU, which controls the entire apparatus through program (including an operating system) execution, a ROM, which stores programs such as a BIOS and an operating system, a RAM, which is used as an execution area for programs, and a communication module, which is used to communicate with external apparatuses. The image processing apparatus 50 outputs an image to the display device 10A via the communication module. The image processing apparatus 50 may be integrally combined with the display device 10A.

Examples of displaying an image on the display surface 11 of a spherical shape include a method to project an image from inside the sphere, a method to project an image from outside the sphere, a method to display an image by turning on light emitting diodes (LEDs) disposed all around the sphere, and a method to use high-speed rotation of a ring-shaped frame that includes LEDs being arranged and that is disposed inside the sphere to make an afterimage of light visible. The display device 10A illustrated in FIGS. 13A and 13B also includes a function to detect a position that the finger 6 of a user touches. In the example in FIGS. 13A and 13B, two arcs L41 and L42, which are lines of longitude, are specified, and thus the display region 40 is set. However, the display region 40 may be circular or rectangular in outline.

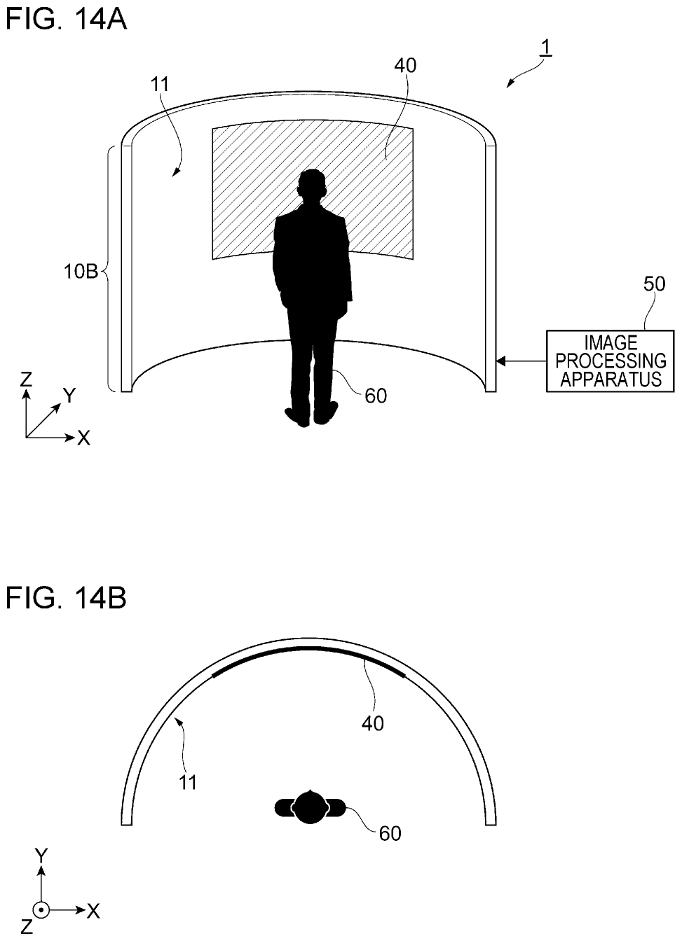

FIGS. 14A and 14B illustrate an example of setting a display region 40 of the information processing apparatus 1 having a concave display surface 11. FIG. 14A is a perspective view of a relative position of the display surface 11 with respect to a user 60, and FIG. 14B is a top view of the relative position of the display surface 11 with respect to the user 60. The information processing apparatus 1 illustrated in FIGS. 14A and 14B includes a display device 10B having the concave display surface 11 and the image processing apparatus 50. The display device 10B illustrated in FIGS. 14A and 14B is not necessarily a single display device and may be an assembly made of a plurality of display devices.

In FIGS. 14A and 14B, the size of the display surface 11 is large compared with the size of the user 60, and the curvature of the display surface 11 is large. In such a case, the user 60 has difficulty in simultaneously viewing the entire display surface 11. Thus, although an image may technically be displayed in the largest display region, the user 60 provides instructions to limit the display region 40 to a portion of the largest display region. The boundary of the display region 40 may be indicated by touching the display surface 11 as described in the examples above. Alternatively, a light spot produced by a laser pointer or the like may be used to indicate the boundary. When a light spot produced by a laser pointer or the like is used, the position of the light spot may be determined in accordance with the position of the light spot that appears in a captured image of the display surface 11.

### Second Exemplary Embodiment

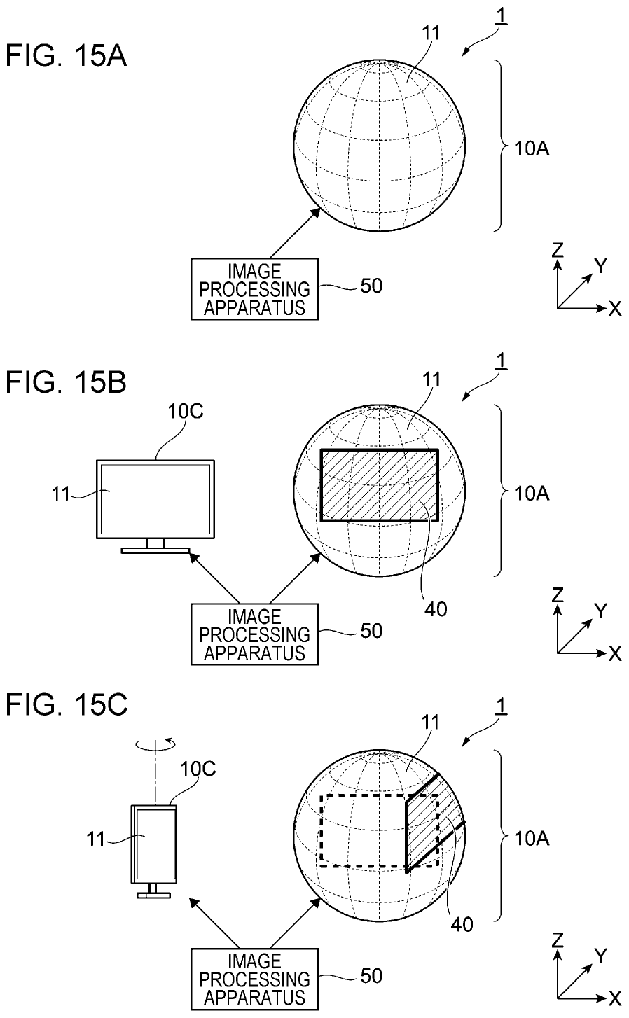

FIGS. 15A, 15B, and 15C illustrate an example of the information processing apparatus 1 according to the second exemplary embodiment. FIG. 15A illustrates a case where an image is output only to the display device 10A having the display surface 11 of a spherical shape. FIG. 15B illustrates a case where an image is output to a display device 10C of a planar shape and the display device 10A having the display surface 11 of a spherical shape. FIG. 15C illustrates a change in the setting of the display region 40 in a case where the display device 10C having a display region of a planar shape is placed facing a different direction.

The information processing apparatus 1 illustrated in FIGS. 15A to 15C includes the display device 10A having the display surface 11, which is a highly transparent sphere and is formed from glass or plastic resin, the display device 10C of a planar shape, and the image processing apparatus 50. Here, the display device 10A is an example of the first display unit, which has a region that is used to display information and that may variably be designated, and the display device 10C of a planar shape is an example of the second display unit, which has a fixed region to display information. In the present exemplary embodiment, the display device 10C of a planar shape has the largest display region of a rectangular shape. One or more small screens (so-called windows) allocated to individual applications may be placed in the largest display region, and some kinds of images are displayed in the entire area of the largest display region.

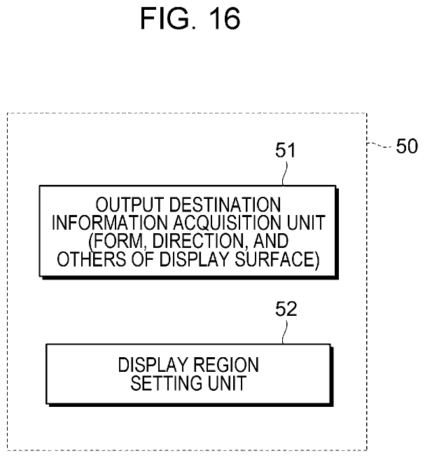

FIG. 16 illustrates an example functional configuration realized by the CPU of the image processing apparatus 50 through program execution. The image processing apparatus 50 in the present exemplary embodiment includes an output destination information acquisition unit 51 and a display region setting unit 52. The output destination information acquisition unit 51 acquires information such as the number of display devices that are output destinations of an image, the form of a display surface constituting each display device, and the direction of each display surface. The display region setting unit 52 sets in accordance with the acquired information the display region 40 of the display device 10A having a curved display surface. The display region setting unit 52 configures settings of the display region 40 not only for the display device 10A having the display surface 11 of a spherical shape but also for a display device having a curved display surface. When output destinations of an image include the display device 10C of a planar shape, the display region setting unit 52 configures settings of the display region 40.

Here, the direction of the display surface of the display device 10C of a planar shape is acquired, for example, from images captured by a camera built into the image processing apparatus 50, by a camera built into the display device 10A, and by a camera disposed at a position from which the two display devices are viewed. For example, the image processing apparatus 50 infers that a user is present in front of the display surface 11 of the display device 10C of a planar shape or in front of the middle point between the display device 10C of a planar shape and the display device 10A having the display surface 11 of a spherical shape. The image processing apparatus 50 in the present exemplary embodiment sets the position and the size of the display region 40 so that the user is able to simultaneously view an image on the display device 10C of a planar shape and an image on the display device 10A. The example in FIGS. 15B and 15C illustrates the way in which the position of the display region 40 of the display device 10A of a spherical shape moves in accordance with the change in the direction of the display surface 11 of the display device 10C of a planar shape. A rectangle represented by a dashed line in FIG. 15C indicates the position of the display region 40 in FIG. 15B.

The image processing apparatus 50 configures settings so that the shape defining the boundary of the display region 40 of the display device 10A of a spherical shape matches the shape of the display surface 11 of the display device 10C of a planar shape when viewed from the position of the user. Thus, the display region 40 is formed into a rectangular shape in FIGS. 15B and 15C. If an image viewed by the user is deformed due to the curved surface of the display region 40, which has been formed into a rectangular shape, the strength of viewing an image on two screens decreases. Thus, the image processing apparatus 50 in the present exemplary embodiment has a correcting capability so that an image that is output to a region designated as the display region 40 is to be viewed in the same way as an image displayed on the display device 10C of a planar shape when viewed from the position of the user. Thus, when an image is displayed on the display device 10C of a planar shape and the display device 10A of a spherical shape, which are placed side by side, a view similar to the view obtained in the case where the image is displayed on two display devices 10C of a planar shape is also realized.

### Third Exemplary Embodiment

A technique to support printing an image displayed on the display surface 11, which extends continuously over an entire perimeter at least in one direction, will be described below. An image display that extends continuously over an entire perimeter, which is achieved by using, for example, a display device of a cylindrical shape or a display device of a spherical shape, is put into practical use because of the recent progress of display technology. A camera that is able to capture an image extending continuously 360° is also available. On the other hand, a technique to print on a sheet an image extending continuously 360° has yet to be put into practical use. Thus, in the present exemplary embodiment, a technique is proposed to set an edge for printing in the case where an image is displayed in a ring-like form on a display device having a display surface extending continuously in a ring-like form at least in one direction.

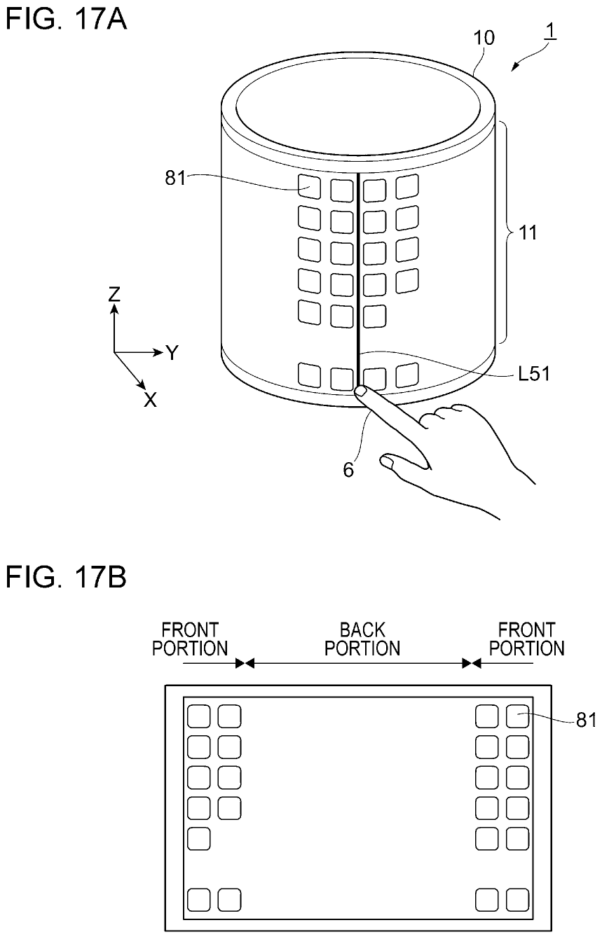

FIGS. 17A and 17B illustrate a method of setting a print region in the third exemplary embodiment. FIG. 17A illustrates an example of setting a print region on the display surface 11 of a cylindrical shape, and FIG. 17B illustrates a print result. The information processing apparatus 1 in FIGS. 17A and 17B is the same as the information processing apparatus 1 in the first exemplary embodiment (refer to FIGS. 1A and 1B). In the present exemplary embodiment, the finger 6, which is in contact with the display surface 11 of a cylindrical shape, is also moved to specify positions as in the first exemplary embodiment.

In the present exemplary embodiment, however, the finger 6 is moved to input a position to specify an edge for printing. In FIGS. 17A and 17B, the finger 6 moves in the longitudinal direction and an edge L51 is set. The finger 6 may not necessarily move on a straight line, and the position on the perimeter on the upper side and the position on the perimeter on the lower side may not be on a vertical line. The information processing apparatus 1 in the present exemplary embodiment has a correcting function so that the edge L51 for printing is arranged perpendicularly to the circular perimeters of the display surface 11. In FIGS. 17A and 17B, the edge L51 is set at a position dividing into two parts an area where icons 81 are arranged in four columns. In addition, in FIGS. 17A and 17B, it is predetermined that printing is performed in the counterclockwise direction from the edge L51. Thus, the print result illustrated in FIG. 17B is obtained only by specifying the edge L51.

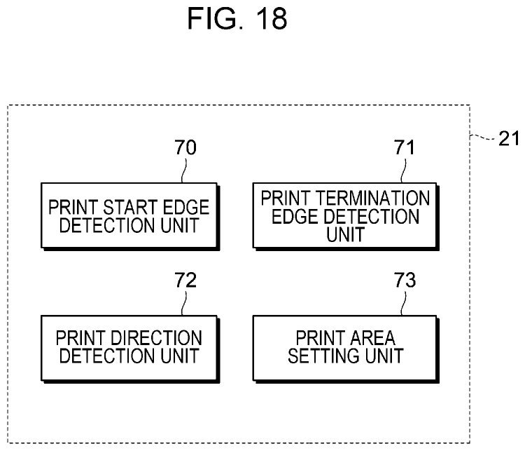

FIG. 18 illustrates an example of a function realized by the CPU 21 (refer to FIG. 2) through program execution. In the present exemplary embodiment, a realized function is acceptance of edges for printing and settings of a print area. Thus, the CPU 21 serves as a print start edge detection unit 70, which detects an edge position where printing is started, a print termination edge detection unit 71, which detects an edge position where printing is terminated, a print direction detection unit 72, which detects instructions on a direction in which printing is performed from the detected edge, and a print area setting unit 73, which sets a print area in accordance with the detected information. When a single position is designated as the edge for printing, the print start edge detection unit 70 and the print termination edge detection unit 71 specify the same position on a perimeter. In contrast, when two positions are designated as the edges for printing, the position designated first is set to the edge where printing is started, and the position designated second is set to the edge where printing is terminated.

The print direction detection unit 72, which has a function to be performed when it is not predetermined whether printing is performed in the clockwise direction or in the counterclockwise direction, detects whether the finger 6 of the user (refer to FIG. 17A) has moved in the clockwise direction or in the counterclockwise direction. When a single position is designated as the edge for printing, the print area setting unit 73 sets a print area extending in the predetermined or detected direction from the detected edge. In contrast, when two positions are designated as the edges for printing, the print area setting unit 73 sets a print area extending in the detected direction from the edge detected first to the edge detected second. When the entire boundary of a print area is specified as in the example in FIGS. 7A and 7B, the print area setting unit 73 designates the specified portion as the print area. In the present exemplary embodiment, each of the print start edge detection unit 70, the print termination edge detection unit 71, the print direction detection unit 72, and the print area setting unit 73 or a combination thereof serves as a receiving unit regarding a print function.

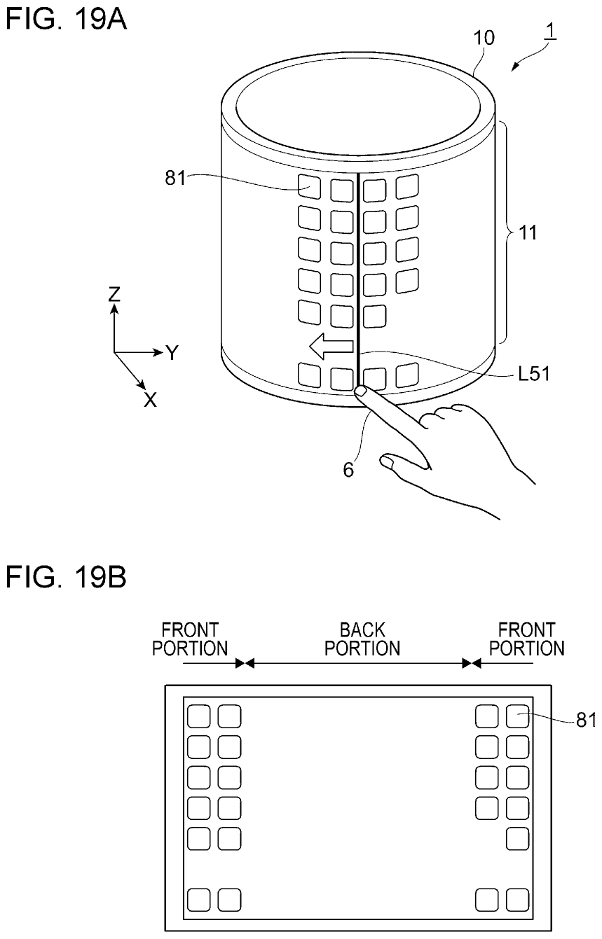

Examples of performing printing will be described below with reference to FIGS. 19A to 21B. FIGS. 19A and 19B illustrate a case where one edge L51 is specified and printing is performed in the clockwise direction. FIG. 19A illustrates an operation by a user, and FIG. 19B illustrates a print result. In the example in FIGS. 19A and 19B, image information is read from the edge L51 in the clockwise direction and printed on a sheet. The print direction in FIGS. 19A and 19B is opposite to the print direction in FIGS. 17A and 17B. Naturally, when the finger 6 is moved from the edge L51 in the counterclockwise direction, the same print result as the print result in FIG. 17B is obtained.

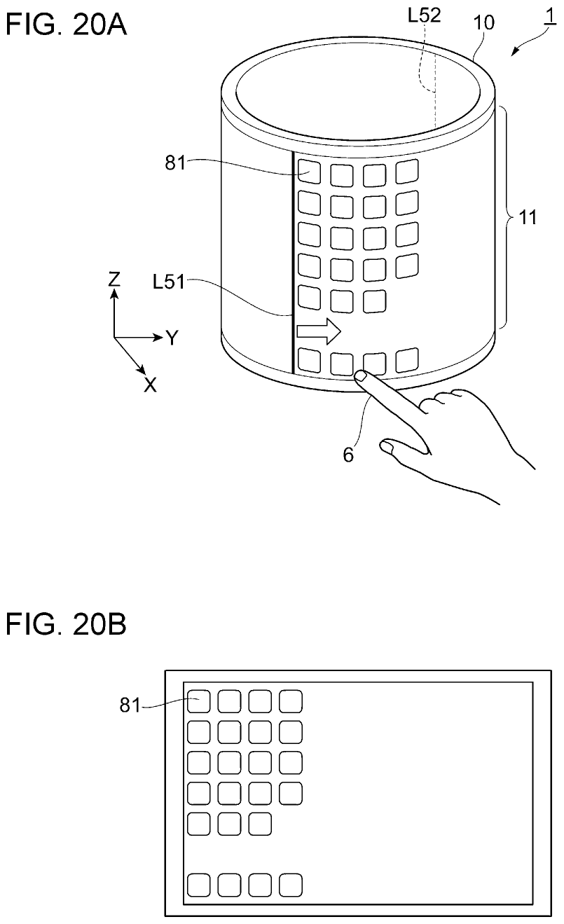

FIGS. 20A and 20B illustrate a case where two edges L51 and L52 are specified and printing is performed in the counterclockwise direction. FIG. 20A illustrates an operation by a user, and FIG. 20B illustrates a print result. Here, the print direction (arrow direction in FIG. 20A) may be specified before the specification of the edges L51 and L52, between the specification of the edges L51 and L52, or after the specification of the edges L51 and L52. The operation illustrated in FIG. 20A enables any portion of an image displayed over the entire perimeter to be selected and printed.

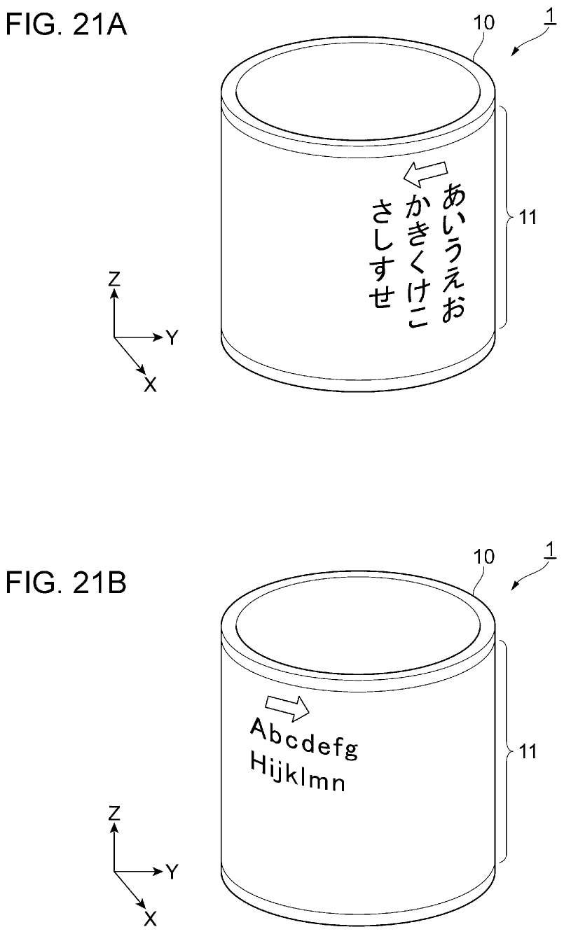

FIGS. 21A and 21B illustrate examples in a case where the print direction is determined in accordance with the content of a displayed image. FIG. 21A illustrates the print direction in a case where text characters are arranged from top to bottom, and FIG. 21B illustrates the print direction in a case where text characters are arranged from left to right. When an image contains a text character sequence arranged from top to bottom, such as kanji or hiragana, the print direction is set to the clockwise direction. On the other hand, when an image contains a text character sequence arranged from left to right, such as the Roman alphabet or numerals, the print direction is set to the counterclockwise direction.

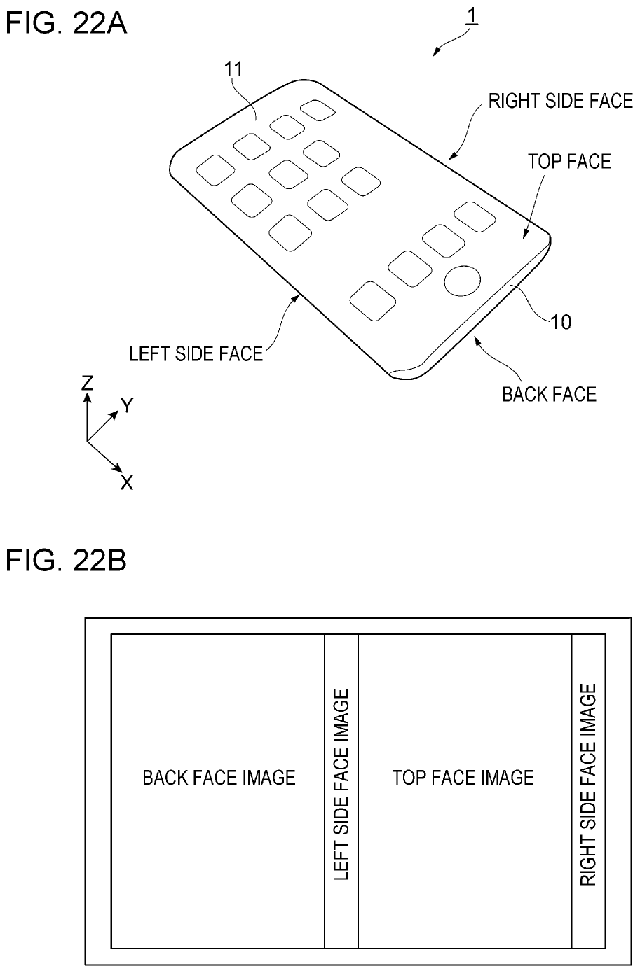

If the display surface 11, which extends continuously over the entire perimeter, may be divided into distinguishable regions in accordance with the physical form, the print area may be set by specifying physical regions. FIGS. 22A and 22B illustrate an example of printing in a case where display regions are distinguishable in accordance with the physical form of the display surface 11. FIG. 22A illustrates an example of regions, each of which is managed as a print unit, and FIG. 22B illustrates a print result in a case where all the regions are selected as an object to print. The information processing apparatus 1 illustrated in FIG. 22A has the main body 10 formed into a substantially flat plate. Thus, the display surface 11 is managed as four regions, which are the top face, the right side face, the back face, and the left side face. In the example in FIGS. 22B, all the four regions are specified as an object to print, and thus all the four regions are printed at corresponding positions.

A region to be printed may be specified, for example, by touching with a finger a certain portion in each region. For a hand-held terminal, such as a smartphone or a tablet, a position on the display surface 11 touched to hold a terminal and a position touched to specify an object to print are difficult to distinguish. Thus, for example, when a predetermined portion in each of the four faces (such as a portion near the bottom of each of the faces) is touched, such a touch may be accepted to specify an object to print.

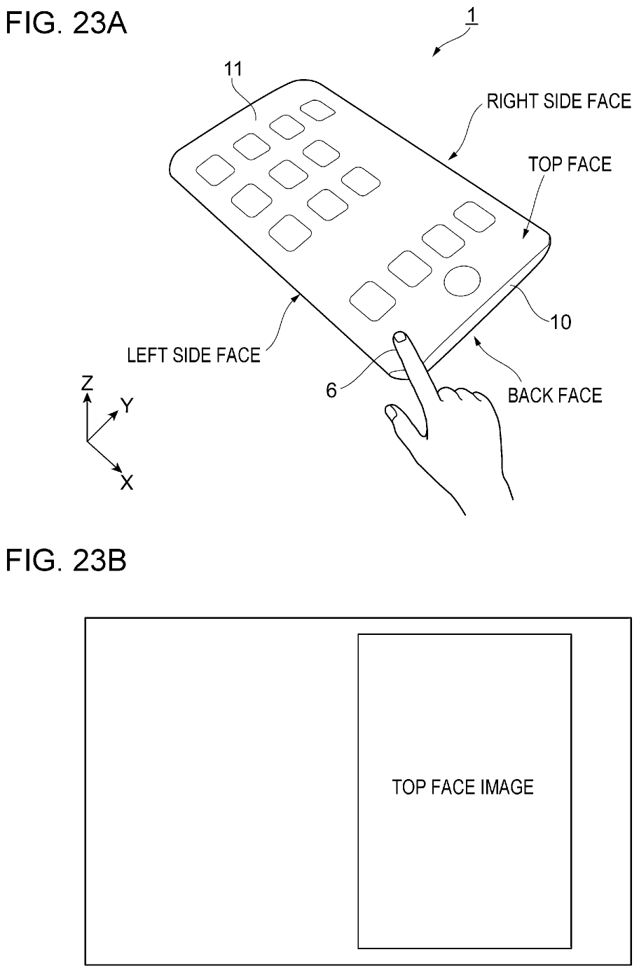

FIGS. 23A and 23B illustrate another example of printing in a case where display regions are distinguishable in accordance with the physical form of the display surface 11. FIG. 23A illustrates an example of regions, each of which is managed as a print unit, and FIG. 23B illustrates a print result in a case where a single region is selected as an object to print. In FIGS. 23A and 23B, the top face among four regions (the top face, the right side face, the back face, and the left side face) that are demarcated to manage the display surface 11 is specified as an object to print. Thus, only a top face image is printed.

### SUMMARY

As described above, the third exemplary embodiment provides the information processing apparatus 1 having an acceptance unit that accepts a position specifying an edge of a region to print in the case where an image is displayed over the entire perimeter of the display surface 11, which has a ring-like form at least in one direction. The acceptance unit described here has a function to accept whether an image displayed on the display surface 11 of a ring-like form is to be printed in the clockwise direction or in the counterclockwise direction from the position accepted as an edge. The acceptance unit described here also has a function to determine a print direction in accordance with the direction in which a text character sequence is arranged. These functions enable the information processing apparatus 1 in the third exemplary embodiment to provide a print result having a layout desired by a user even in the case where an image is displayed over the entire perimeter of the display surface 11, which has a ring-like form at least in one direction.

### Other Exemplary Embodiments

The exemplary embodiments of the present disclosure have been described as above, but the technical scope of the present disclosure is not limited to the range described in the exemplary embodiments above. It is apparent from the description in the claims that various modifications and improvements made to the exemplary embodiments described above do not depart from the technical scope of the present disclosure.

For example, the display surface is formed on a physical component in the exemplary embodiments described above but may be formed optically as an image in the air (hereinafter, referred to as an “aerial image”). An aerial image is an optically formed image and thus may have any form. Possible examples include a flat surface, a curved surface, a sphere, and a cube.

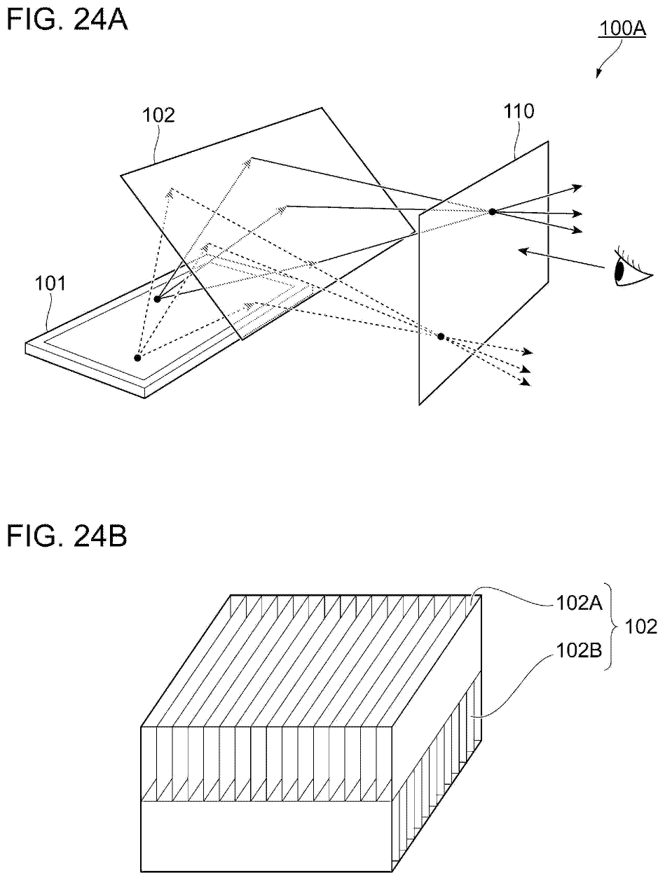

For reference purposes, principles of forming an aerial image will be described with reference to FIGS. 24A to 27. FIGS. 24A and 24B illustrate a principle of an aerial image forming apparatus 100A, which forms an aerial image 110 by using light that is output from a display device 101 and that thereafter passes through a dedicated optical plate 102. FIG. 24A illustrates a relative position of the aerial image 110 with respect to each component, and FIG. 24B illustrates a portion of a sectional view of the structure of the optical plate 102.

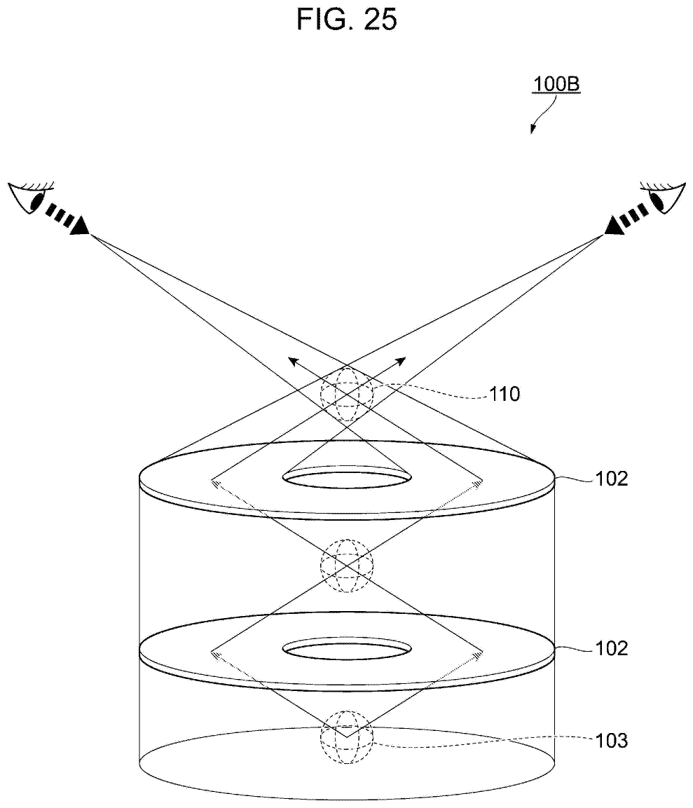

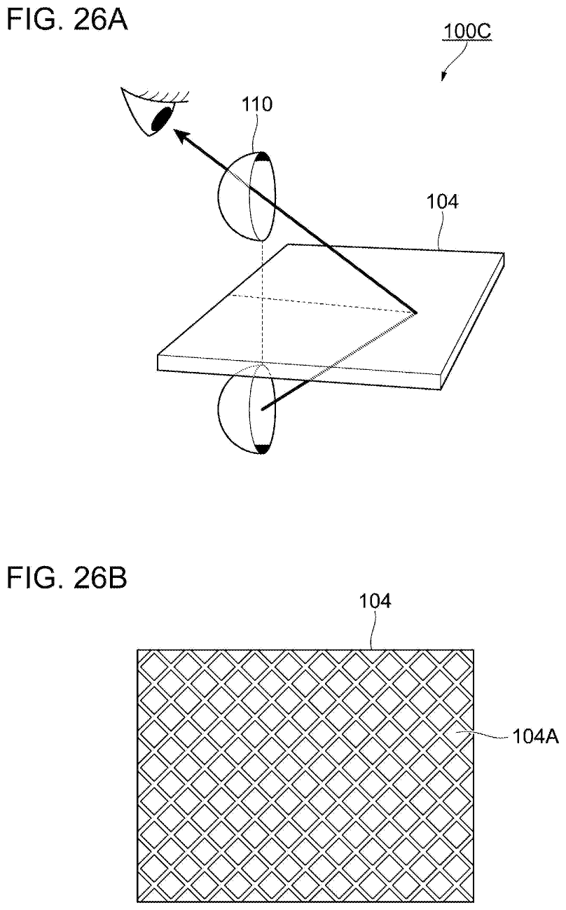

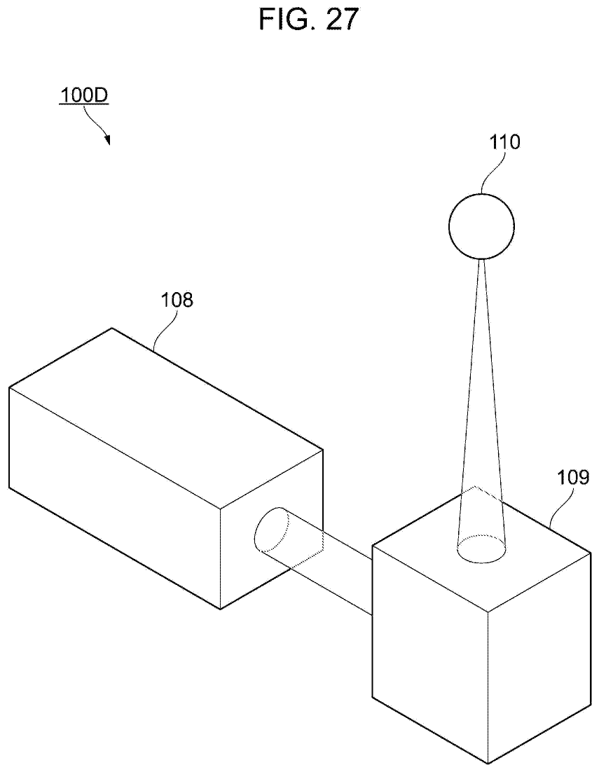

The optical plate 102 described here has the structure in which a plate having arrayed strips of glass 102A whose major surfaces are used as mirrors is placed on top of another plate having arrayed strips of glass 102B, which are arrayed in the direction perpendicular to the array direction of the strips of glass 102A. The optical plate 102 twice reflects light that is output from the display device 101 on the strips of glass 102A and on the strips of glass 102B and forms an image in the air, thereby reproducing in the air an image displayed on the display device 101. The distance between the display device 101 and the optical plate 102 is the same as the distance between the optical plate 102 and the aerial image 110. In addition, the size of the image displayed on the display device 101 and the size of the aerial image 110 are the same. The aerial image forming apparatus 100A described here is an example of an information processing apparatus. Aerial image forming apparatuses 100B (refer to FIG. 25), 100C (refer to FIGS. 26A and 26B), 100D (refer to FIG. 27), which will be described below, are also examples of the information processing apparatus.

FIG. 25 illustrates a principle of the aerial image forming apparatus 100B, which forms a three-dimensional image as an aerial image 110. The aerial image forming apparatus 100B reproduces a three-dimensional image in the air by using light that is reflected on the surface of an actual object 103 and that thereafter passes through a pair of ring-shaped optical plates 102. It is not necessary to arrange the pair of optical plates 102 in series.

FIGS. 26A and 26B illustrate a principle of the aerial image forming apparatus 100C, which forms an aerial image 110 by using a micromirror array 104 having a structure of tiny rectangular holes 104A arranged in a plane at a constant pitch. Each of the tiny rectangular holes 104A constitutes a dihedral corner reflector. FIG. 26A illustrates a relative position of the aerial image 110 with respect to each component, and FIG. 26B is an enlarged view of a portion of the micromirror array 104. A single hole 104A is formed, for example, with the size of 100 μm square.

FIG. 27 illustrates a principle of the aerial image forming apparatus 100D, which forms an aerial image 110 as a collection of plasma light emitters. In the aerial image forming apparatus 100D, an infrared pulse laser 108 outputs pulsed laser light, and an XYZ scanner 109 converges the pulsed laser light in the air. At this time, the gas close to the focal point is instantaneously converted to plasma and emits light. The pulse frequency achieved in this example is, for example, 100 Hz or less, and the pulse emission duration is, for example, on the order of nanoseconds.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an acceptance unit that accepts designation of a region to be used to display information on a display unit having a curved display surface.

2. The information processing apparatus according to claim 1,
wherein the curved display surface is deformable in shape.

3. The information processing apparatus according to claim 1,
wherein the acceptance unit accepts any portion of the curved display surface as the region.

4. The information processing apparatus according to claim 3,
wherein the acceptance unit accepts the designation of the region through a specified operation on the curved display surface.

5. The information processing apparatus according to claim 3,
wherein the acceptance unit accepts designation of at least a portion of a boundary that defines the region.

6. The information processing apparatus according to claim 5,
wherein the acceptance unit accepts the designation of at least a portion of a boundary that defines the region and designation of a direction in which an image is displayed from the portion as a start point.

7. The information processing apparatus according to claim 1,
wherein the display unit is being worn when in use.

8. The information processing apparatus according to claim 1,
wherein the curved display surface is presented as if floating in the air.

9. The information processing apparatus according to claim 1,
wherein the display unit having a curved first display surface is a first display unit having a first region that is used to display information and that is variably designated, and
when the first display unit and a second display unit having a second region that is used to display information and that is fixed are designated as destinations to which information is output, the acceptance unit changes a position of the first region of the first display unit in accordance with a direction that the second region of the second display unit faces.

10. The information processing apparatus according to claim 9,
wherein the acceptance unit changes a shape of the first region of the first display unit in accordance with a shape of the second region of the second display unit.

11. An information processing system comprising:
a display unit that has a curved display surface; and
an acceptance unit that accepts designation of a region to be used to display information on the display unit.

12. A non-transitory computer readable medium storing a program causing a computer to execute a process for information processing, the process comprising:
accepting designation of a region to be used to display information on a display unit having a curved display surface.

13. An information processing apparatus comprising:
acceptance means for accepting designation of a region to be used to display information on a display unit having a curved display surface.
